(19) United States
(12) Patent Application Publication
(10) Pub. No.: US 2024/0345374 A1
(43) Pub. Date: Oct. 17, 2024

(54) ILLUMINATION SYSTEM, SPECIFIC USE OF AN ILLUMINATION SYSTEM, ILLUMINATION METHOD AND OBSERVATION SYSTEM

(71) Applicant: Schölly Fiberoptic GmbH, Denzlingen (DE)

(72) Inventors: Cyril Autourde, Kunheim (FR); Julian NEHLICH, Freiburg (DE); Johannes BOURBON, Freiburg (DE)

(73) Assignee: Schölly Fiberoptic GmbH, Denzlingen (DE)

(21) Appl. No.: 18/625,557

(22) Filed: Apr. 3, 2024

(30) Foreign Application Priority Data
Apr. 13, 2023 (DE) 102023109263.4

(51) Int. Cl. G02B 21/00; G02B 21/08

(52) U.S. Cl. CPC G02B 21/0032; G02B 21/0028; G02B 21/006; G02B 21/082

(57) ABSTRACT

To improve the luminous efficiency and compactness of an illumination system that is usable together with an imaging visualization system, the illumination system includes two microlens arrays, which are either displaceable relative to one another along an optical axis or at least one of the microlens arrays is optically tunable, such that in each case an effective focal length of the condensing optical unit formed by the microlens arrays is variable. Accordingly, the size of an illumination field illuminated by the condensing optical unit is adaptable situation-dependently and extremely rapidly, in particular if a focal plane observed by the visualization system is displaced or an optical zoom of the system is altered. As a result, an optimum illumination of the respective field of view is guaranteed, specifically without a portion of the illumination beam path of the illumination system having to be stopped down to a greater or lesser extent.

### CROSS-REFERENCE TO RELATED APPLICATIONS

This application claims priority to German Patent Application No. 10 2023 109 263.4, filed Apr. 13, 2023, which is incorporated herein by reference as if fully set forth.

### TECHNICAL FIELD

The invention relates to an illumination system provided for adaptively illuminating an object situated in an object plane. In this case, the illumination system can be used together with an imaging system and/or can be integrated into an imaging system. The illumination system has or forms an illumination beam path and comprises therefor: a light source as the starting point of the illumination beam path; a collector optical unit for collecting light beams emerging from the light source; and a condensing optical unit for illuminating said object plane.

The invention furthermore relates to a specific use of such an illumination system for illuminating an object plane which is simultaneously observed by an imaging visualization system.

The invention also relates to a method for shading-free illumination of a cavity such as, for example, a body cavity, wherein the cavity is observed by a visualization system and wherein illumination light emerging from a light source firstly is at least approximately collimated by means of a collector optical unit.

Finally, the invention relates to an observation system which is suitable for medical applications, in particular, and which comprises an illumination system according to the invention and also an imaging visualization system offering a variable optical zoom.

### BACKGROUND

In the prior art, illumination systems of this type are already used in medical interventions in order to illuminate an object field which is observed by a surgeon by way of a video camera with a corresponding imaging optical unit.

### SUMMARY

Taking this as a departure point, the invention is based on the object of enabling improved handling and performance of the overall system precisely in such applications. In particular, the intention is to provide a highly compact, lightweight and energy-efficient illumination system for such applications which is able to move freely in space together with the imaging system on a robotic arm.

In order to achieve this object, one or more of the features according to the invention are provided in the case of an illumination system. In particular, therefore, according to the invention, in order to achieve the object, in the case of an illumination system of the type mentioned in the introduction, it is proposed that the condensing optical unit comprises two microlens arrays.

Furthermore, it is provided that an axial distance between the two microlens arrays is configured to be adjustable along an optical axis. Alternatively or supplementarily to the aforementioned feature, it can also be provided that at least one of the two microlens arrays is configured to be optically detunable.

In other words, according to the invention, a variable adaptation of an illumination field illuminated by the illumination system can thus be achieved by adapting the axial distance between the two microlens arrays of the condensing optical unit and/or by optically detuning at least one of the two microlens arrays. The use of such microlens arrays results in an extremely efficient design and furthermore affords further diverse technical advantages that will be explained in even more specific detail.

According to the invention, the object can also be achieved by further advantageous embodiments as described below and in the claims.

By way of example, an optical focal length of the condensing optical unit can be tunable by adjusting the axial distance between the two microlens arrays or by detuning at least one of the two microlens arrays.

The illumination system can furthermore be configured such that a size of an (the abovementioned) illumination field in the object plane, which illumination field is supplied with illumination light by the condensing optical unit, is adaptable by i) adjusting the axial distance between the two microlens arrays and/or is adaptable by ii) detuning at least one of the two microlens arrays. Such an adaptation can take place for example with constant working distance between the object plane and the condensing optical unit; however, the adaptation can also take place in reaction to an adaptation of the working distance.

By adapting the focal length of the condensing optical unit, i.e. for example by adjusting the axial distance, it is thus possible to produce a kind of zoom effect in relation to the size of the illumination field illuminated by the condensing optical unit. Such an adaptation of the size of the illumination field by adjusting the focal length of the condensing optical unit (attained by displacing one of the microlens arrays along the optical axis) can be advantageous in particular if the working distance has changed and, for instance, the associated visualization system is/has been correspondingly set to an altered focal distance (=adaptation of the focus of the imaging system).

The illumination system can also have a luminous field stop inserted into the illumination beam path, for example arranged between the collector optical unit and the condensing optical unit or in the illumination beam path downstream of the condensing optical unit or even upstream of the collector optical unit. In this case, this luminous field stop is preferably arranged such that its stop aperture is always completely illuminated by the illumination beam path. In such a case, the luminous field stop can thus stop down a portion of the light beams emerging from the collector optical unit. Preferably, however, only a minimal portion of the illumination beam path is ever stopped down, such that almost the entire illumination light of the light source also actually arrives in the object plane.

The condensing optical unit can thus be designed to image an image of the luminous field stop in different magnifications onto the object plane (which typically remains at the same working distance in the course of the application). As a result, a sharp image representation of the luminous field stop arises in each case in the object plane, this image representation precisely defining, i.e. predetermining, the illumination field.

In this case, the light source can preferably be arranged in relation to the collector optical unit such that the collector optical unit images the light source into infinity. This is because a so-called Köhler illumination can be realized by the illumination system in this case, and then the light source no longer disturbs the imaging in the object plane.

The adaptation of the size of the illumination field can preferably be configured such that an aspect ratio (height to width) of the illumination field remains invariable and/or without a stop size having to be altered in the process. This can be achieved for example if the condensing optical unit images an invariable luminous field stop with a fixed aspect ratio in different imaging scales onto the object plane, depending on the degree of adjustment of the condensing optical unit. Such a configuration of the illumination system makes it possible to implement a variable or adaptive Köhler illumination, specifically in particular without using a variable luminous field stop. Such an illumination allows the axial position and/or size of the illuminated illumination field to be adapted by adjusting the condensing optical unit.

The distance between the object plane and the condensing optical unit, in particular the back microlens array, can be understood here as a working distance of the illumination system. If this working distance is kept constant during the use of the illumination system, then it is possible, in particular without altering the position and/or size of a luminous field stop, to adapt the size of the illumination field, namely by displacing one of the two microlens arrays.

In the simplest case, the collector optical unit can be formed by a single stationary, in particular aspherical or else planoconvex, optical lens. However, the collector optical unit can also be more complex and then comprise for example a plurality of optical lenses, in particular two planoconvex lenses.

By virtue of the more efficient utilization of light, the invention affords the advantage that the light power and thus the electrical power consumption of the light source can be reduced. Moreover, the individual components can thus be better adapted to the lower power range. Furthermore, the increased efficiency leads to lower power losses and thus to less heating of the illumination system, in particular in the region of light coupling locations. Since the light source can be implemented with lower power, a lower safety class can be complied with in particular at the coupling locations of a light guide used as light source of the illumination system, said light guide supplying the light from a primary light source to the collector optical unit, and this affords advantages for the user.

In accordance with one advantageous configuration, the two microlens arrays can shape an incident beam of the illumination beam path into an emerging beam which results in a rectangular format, preferably of 16:9, of the illumination field. In this case, the light source can supply a non-rectangular, for example approximately rotationally symmetrical, intensity distribution, which is the case for many customary light sources. In other words the beam emerging from the two microlens arrays can thus have rectangular beam cross section.

A major advantage of the invention is that the two microlens arrays can cause an optical homogenization of an intensity distribution within the rectangular illumination field, in comparison with an (original) intensity distribution of the light source of the illumination system. The two microlens arrays thus perform the optical functions of beam homogenization and beam shaping in relation to the illumination beam path emerging from the condensing optical unit.

It can be particularly advantageous for this if both microlens arrays each have microlenses on both sides (i.e. on their respective front and rear sides).

The two microlens arrays can for example each have, i.e. in particular each have on the front side and/or rear side, microlenses having a rectangular basic shape and/or a rectangular optical aperture. Furthermore, configurations are possible in which the microlenses of the two microlens arrays are arranged in a respective periodic pattern. As a result, a flat-top intensity profile with a waviness of less than 15% can be attained in the illumination field.

Furthermore, at least one of the two microlens arrays can have microlenses with an aspherical contour.

By way of example, it can also be provided that at least one of the two microlens arrays has cylindrical lenses. In this case, at least one of the two microlens arrays can have cylindrical lenses on both sides, wherein an orientation of these cylindrical lenses is rotated by 90° between a front side and a rear side (36). Alternatively or supplementarily thereto, the cylindrical lenses of one microlens array can also be rotated by 90° relative to the cylindrical lenses of the other microlens array.

What is achievable by means of such configurations is that a beam transformation from a circular to a rectangular illumination is attained. This is because, for this purpose, the illumination beam originally in the shape of a circular disk has to be diverted to different extents along two mutually perpendicular axes. This can be attained by way of the different radii of curvature of the microlenses, although these need not necessarily be configured to be different; by way of example, a rectangular illumination shape can also already be achieved by way of the above-described rotation by 90° between front- and rear-side microlenses.

In other words, it is not compulsory that the radii of curvature of the microlenses must turn out to be different. Rather, the rectangular illumination shape can already be achieved by way of a rotation of the lenses of the two microlens arrays or of front- and rear-side lenses of one of the two microlens arrays with respect to one another, as already mentioned above.

Furthermore, the two microlens arrays (MLAs) can be produced from fused silica in order to enable an illumination across a wide wavelength range right into the UV range. In principle, however, the MLAs can be produced from a wide variety of materials. Glass pressing can also be used for the production of the MLAs, in which case glasses having a low melting point are then preferable.

Preferably, the illumination system has a setting means, by which the axial distance between the two microlens arrays is adjustable. Such a setting means can be a manual setting means, for example.

Precisely for demanding applications in which a precise adaptation of the illumination field is intended to be effected frequently and rapidly, configurations are preferred, however, in which the setting means is configured in the form of an electronically controllable actuator. Such an actuator can be realized for example by a motor, in particular a stepper motor, or a driven cam disk/driven cam tube, by means of an electromagnetic drive or by means of a linear drive.

Such electronic solutions make it possible to adapt the size of the illumination field very rapidly depending on the current size of a field of view of the imaging system. In this case, this possibility of the situation-dependent rapid adaptation of the illumination field to the size of the field of view is a key aspect of the present invention.

In particular, the illumination system can be configured for this purpose such that it can perform/performs a corresponding adaptation of the size of the illumination field automatically in reaction to a change in the size of the field of view of the imaging system. For this purpose, the illumination system can have a(n electronic) controller which performs an adaptation of the size of the illumination field (namely by adjusting the axial distance between the two microlens arrays) in reaction to an input signal (which can be provided by the illumination system or by a user). The controller can achieve this by controlling the setting means of the condensing optical unit. As mentioned, in such a case, the setting means can comprise an, preferably electronically controllable and/or electrically configured, actuator which can cause the desired change in the distance between the two microlens arrays (i.e. at least one displacement of at least one of the two microlens arrays). The actuator can alternatively also be configured such that it detunes at least one of the two microlens arrays.

What is achieved particularly effectively by such configurations is that, at a specific, in particular fixed, working distance, the size of the illumination field can be adapted quickly and precisely. In this case, the illumination system can preferably be configured (by way of corresponding dimensioning of lenses, stops and positioning of these elements along the illumination beam path) such that in the entire adjustment range of the condensing optical unit almost the entire illumination light incident on the front microlens array of the two microlens arrays can be used for illuminating the illumination field.

In contrast to previous systems, in which the size of the illumination field is reduced by greater stopping down, i.e. by reducing the stop aperture of a luminous field stop, in this solution according to the invention the losses are reduced in the illumination beam path, such that almost the entire light can be used for illuminating the field of view. Consequently, almost the entire quantity of light is always available for illuminating the illumination field, independently of the instantaneous adjustment of the condensing optical unit and thus independently of the size of the illumination field. Therefore, hardly any illumination light is lost and excessive heating of the illumination system during operation can thus be avoided since the light beams emerging from the collector optical unit are almost completely used for illumination and, consequently, do not have to be significantly stopped down. As a result, this leads to an increase in the efficiency and, accordingly, the required total light power of the illumination system can be reduced.

It can thus be provided that in at least two different adjustments of the condensing optical unit a quantity of light of the illumination beam path which is provided by the light source and which leaves the collector optical unit completely passes through the two microlens arrays and/or is completely usable for illuminating the illumination field. It goes without saying that unavoidable light losses, for instance owing to scattering at particles, etc., are disregarded in this consideration.

It can thus be provided, however, that the size of the illumination field is settable in an adjustment range of the condensing optical unit, without the light energy incident on the respective illumination field changing in the process. In this case, an adapted intensity/irradiance will then arise on account of the adapted size of the illumination field. Such a configuration can be attained by corresponding sufficiently large dimensioning of the collector and condensing optical units.

Therefore, it can also be provided that an entire light beam emitted by the collector optical unit, in all settable relative positions of the two microlens arrays, exits as a shaped beam from the back microlens array of the two microlens arrays.

If the total quantity of light incident on the illumination field is intended to be reduced, this can be achieved by reducing the quantity of light emitted by the light source, i.e. the light power of the light source can be correspondingly reduced. Therefore, it is also preferred if the light source of the illumination system is configured to be electrically settable in terms of its light power.

The light source mentioned hitherto can also be formed by the end face of a light guide. In the case of such a configuration, the collector optical unit can thus be operated directly at the light guide. In this case, therefore, only the light guide has to be supplied with light from a corresponding primary light source in order that the illumination system can perform its function. The light guide and the corresponding light incoupling into same can preferably be chosen here such that the end face emits light with a maximum emission angle of less than 40°, preferably of less than 20°. Specifically, this makes it possible for the diameter of the first collector lens and thus also of the further downstream components of the illumination system to be kept small and thus for the entire system to be kept extremely compact, which is highly advantageous in particular if the system is intended to be moved in space by a robotic arm. Said light guide can be implemented for example with the aid of a light guide bundle.

In order to achieve the object, the features of the alternative independent use claim are also provided; the latter proposes a specific use of an illumination system as described in the introduction, which illumination system is of course preferably configured according to the invention. In the case of this use, it is provided that in reaction to i) an adaptation of an optical zoom, in particular with constant working distance between the object plane and the condensing optical unit, and/or ii) an adaptation of a spatial pose of a focal plane of the visualization system (together with which said illumination system is used), a size of the illumination field in the object plane (which illumination field is illuminated by the illumination system) is adapted by way of the condensing optical unit being adjusted. For this purpose, the condensing optical unit can be detuned, for example, and/or in particular the axial distance between the two microlens arrays of the illumination system can be adjusted.

As a consequence of the detuning/adjustment of the condensing optical unit, it can happen, in particular, that a luminous field stop of the illumination system is imaged into the object plane only unsharply by the condensing optical unit; however, this is noncritical for many applications and only leads to a less abrupt drop in light intensity at the edge of the illumination field. The illumination field may thus have unsharp edges under certain circumstances, and so there the light intensity no longer drops abruptly, but rather gradually, at the edge. This appears to be noncritical precisely during a zoom-out, however, if the surgeon just controls the positioning of the surgical instruments using the visualization system in order subsequently to zoom into the operation area again (zoom-in, optionally in conjunction with reducing the working distance), to outline one possible application.

The invention has thus recognized that it makes sense, in reaction to changes in both the above input variables (optical zoom/set working distance, i.e. pose of the focal plane), to perform a corresponding adaptation of the optical zoom of the Köhler illumination, i.e. to correspondingly adjust/tune the condensing optical unit of the illumination system. What can be achieved as a result is that, firstly, the entire field of view currently observed is always illuminated and that, secondly, as little light as possible outside this field of view is directed into the observed object plane/working plane, since this light would inevitably be lost for the imaging and would only lead to the heating of the surrounding tissue, which should be avoided. At the same time, as a result, the efficiency of the illumination system overall is increased, or the quantity of light provided by the illumination system is optimally used.

The visualization system used together with the illumination system can be configured for example as a microscope, as an exoscope or as an endoscope.

The visualization system can furthermore be positioned together with the illumination system by a robotic arm in space at a predeterminable working distance from the object to be observed. For this purpose, in particular, the illumination system and the visualization system can be mounted on the robotic arm; furthermore, the illumination system can also be integrated into the visualization system, as already mentioned in the introduction.

One preferred use or configuration provides that an electronic control loop is implemented between the illumination system and the visualization system, specifically in such a way that the illumination system automatically and independently performs the adaptation of the size of the illumination field as soon as a user or some other entity (for instance a controller) of the visualization system alters the optical zoom thereof or the spatial pose of the focal plane of the visualization system. What can be achieved as a result is that the size of the illumination field automatically decreases and/or the illumination intensity in the illumination field automatically increases if a zoom-in is carried out by the visualization system. Depending on the set optical zoom of the visualization system, in this case a light power of the light source of the illumination system can also be, in particular additionally, automatically readjusted in order thus to enable an optimum illumination.

In other words, for example, if a user or a(n electronic) controller focuses the visualization system on a new working distance by way of the user/controller altering the spatial pose of the focal plane of the visualization system and/or if the user/controller carries out a zoom-in or zoom-out with the optical zoom of the visualization system, then the illumination system in each case automatically adapts the size of the illumination field, preferably by altering the axial distance between the two microlens arrays or by tuning the condensing optical unit. This can be implemented for example in such a way that with reduced working distance, i.e. shorter distance between the system and the focal plane, and/or when a zoom-in is performed using the visualization system, an aperture angle of an illumination light cone emerging from the illumination system is automatically reduced; for the size of the illumination field also decreases as a result. With maximum working distance and/or maximum zoom-out, by contrast, the aperture angle of the illumination light cone can be chosen precisely with maximum magnitude in order thus to still completely illuminate the (then magnified) field of view of the visualization system.

In the case of such a use, a point of intersection between an optical axis of the illumination system and an optical axis of the visualization system can lie within a visual range of the visualization system, with the visualization system supplying a sharp image representation/imaging within the visual range.

In order to achieve the stated object, the features of the independent method claim are provided according to the invention. In particular, therefore, according to the invention, in order to achieve the object, in the case of an illumination method of the type described in the introduction, which method is usable in particular for shading-free illumination of a cavity, it is proposed that the illumination light is subsequently (i.e. after passing through the collector optical unit) guided through two successive (in the illumination beam path) microlens arrays, which perform beam shaping and beam homogenization; and that the illumination light is finally passed through at least two, preferably nonmovable or stationary, imaging lenses of an imaging optical unit of the visualization system right into an object plane observed by the visualization system, said object plane lying within the cavity, for example.

It goes without saying that it is particularly expedient here if an illumination system according to the invention and a visualization system as described above are used for carrying out this method.

What is advantageous about this method is that the illumination light can be incident on the object plane at almost the same angle at which an optical axis of the visualization system impinges on the object plane (this therefore corresponds to the viewing angle realized by the visualization system in relation to the object plane). This makes it possible to avoid shading in the relevant viewing direction.

In order to achieve the object, the features of the alternative independent claim directed to an observation system are furthermore provided. In particular, therefore, in order to achieve the object, in the case of an observation system of the type mentioned in the introduction, it is proposed that the at least one illumination system and the visualization system are designed in each case for a use as described above and/or in accordance with one of the claims directed to a use and/or for carrying out the method described above. The observation system can also be characterized by the fact that the illumination beam path of the illumination system is passed through at least one imaging lens, preferably through a plurality of imaging lenses, of the visualization system.

In the case of such a configuration, therefore, part of an optical objective of the visualization system can be used jointly for implementing an imaging beam path of the visualization system and for beam shaping of the illumination beam path. In other words, the condensing optical unit of the illumination system then comprises not only the two microlens arrays, but also those imaging lenses of the visualization system which concomitantly shape the illumination beam path. Therefore, the illumination beam path then exits from the last imaging lens of the visualization system.

This approach has the major technical advantage that a parallax angle that exists between the optical axes of the illumination beam path and the imaging beam path can almost completely disappear. This is advantageous in order to produce substantial freedom from shading during illumination and simultaneous observation of the cavity.

The approach according to the invention furthermore has the advantage that—in contrast to a traditional “fly's eye condenser” based on a microlens array—a separate Fourier lens in the illumination system is not required since the imaging lenses that concomitantly shape the illumination beam path perform the function of the Fourier lens here. Therefore, precisely the joint use of lenses in conjunction with the use of microlens arrays in the condensing optical unit of the illumination system appears to be innovative, specifically because lenses can thereby perform a double optical functionality (imaging and Fourier transformation).

It should also be noted that, in the case of an observation system configured according to the invention, it is not absolutely necessary for the illumination system and the imaging system to share a common optical element. For depending on the application this may even have disadvantages with regard to the problem of scattered light.

Alternatively or supplementarily to the features explained above, in the case of the observation system, it can also be provided that the latter is mounted on a movable robotic arm, by which the observation system is arrangeable in space in different positions and/or in different viewing directions.

It can furthermore be provided that at least one optical axis of the at least one illumination system and an optical axis of the visualization system are arranged at a, in particular respective, parallax angle with respect to one another. In such a configuration, too, the visualization system and the illumination system can share optical elements; however, the opposite can be the case as well. Furthermore, in particular with the use of two microlens arrays as described above in the illumination system, the parallax angle can be configured to be adaptable/variable, for example by means of a corresponding adjustment mechanism.

By way of example, if two adaptive illumination systems configured according to the invention are used in the west and east in relation to the optical axis of the visualization system, then two parallax angles with the same magnitude, oriented symmetrically with respect to the latter axis, can be configured.

If a field of view captured by sensor in a landscape orientation (for instance in the 16:9 format) is implemented in the visualization system, it is preferred if the two illumination systems are arranged at the ends of the longer side of the field of view. The use of two illumination systems in the west and east with respect to the optical axis of the visualization system is advantageous in particular if a body cavity is intended to be observed using the visualization system. This is because if only one illumination system were used, edge shading could then occur, specifically along that axis (east-west axis) along which the illumination system is offset laterally with respect to the visualization system.

By contrast, the use of at least one common optical element in the imaging and illumination beam paths has the major advantage that it may then be sufficient to configure just an adaptive Köhler illumination with the aid of the two microlens arrays, in which case only one illumination system can then illuminate the observation field from one side. With the small parallax angles that then occur, the low edge shading resulting therefrom may still be acceptable in a surgical situation. Complexity can be saved as a result.

It can also be provided that the illumination beam path runs through an axially displaceable imaging lens of the visualization system. Specifically, in this case, a, preferably simultaneous, change in the size of an illumination field illuminated by the illumination beam path together with a change in a field of view and/or a working distance of the visualization system can be achieved by axial displacement of said imaging lens. This displaceable imaging lens can be configured in particular as an entire lens group as part of a focusing optical unit. Working distance of the visualization system can be understood here to mean the distance between the first lens surface of the visualization system and a focal plane that is sharply imaged by the visualization system.

The aim which is intended to be achieved with the axial displacement of the jointly used lenses of the visualization system and of the illumination system is therefore a change in the illumination field simultaneously with the change in the field of view or the working distance, specifically without the need here to carry out an explicit adaptation of the illumination field by changing the distance between the two microlenses. By way of an additional adaptation of the distance between the two microlenses, however, the size of the illumination field can then additionally be adapted as well. As a result, it is thus possible to achieve functionally a separation between a change in the illumination field in the case of a change in the working distance or in the case of a change in the zoom of the visualization system. In the case of an axial displacement of the jointly used lenses of the visualization system and of the illumination system, a lateral displacement of the illumination field may also occur under certain circumstances, this then merely being a more parasitic effect.

A further configuration provides for the parallax angle described to be configured to be variable. For this purpose, in particular, the optical axis of the illumination system and/or the optical axis of the visualization system can be configured to be tiltable.

Supplementarily or alternatively, for example, a conversion mechanism can be implemented, preferably in such a way that an adjustment of a focusing optical unit of the visualization system that serves for adapting the spatial pose of the focal plane is convertible (preferably purely mechanically) into a corresponding tilt of the optical axis of the illumination system. What can thereby be achieved, in particular, is that the parallax angle is automatically adaptable depending on the current pose of the focal plane.

It can also be provided that the optical axis of the illumination system is configured to be tiltable. This can be the case, for example, since a condenser lens of the condensing optical unit is configured to be displaceable and/or tiltable transversely with respect to this optical axis or since the entire illumination system is configured to be tiltable in relation to the visualization system.

In the case of such configurations, a deflection prism is not absolutely necessary; however, a deflection prism or some other deflection element can additionally be inserted into the beam path in order to attain a deflection of the illumination beam path and thus to achieve a different arrangement of the illumination within the system, for instance in order to improve the compactness of the system.

The laterally displaceable condenser lens, sometimes also referred to as projector lens, can preferably follow the two microlens arrays in the beam path. The adaptation of the parallax angle can thus be attained by a lateral displacement of such a projector lens, wherein in this case this laterally displaceable projector lens is preferably arranged downstream of the two microlens arrays in the beam path.

By means of the conversion mechanism, which can optionally also comprise actuators, a desired tilting of the optical axis of the illumination system can thus be set automatically, depending on the working distance on which the visualization system is currently focused. If the working distance is small (short distance between focal plane and visualization system), the parallax angle between the two optical axes has to turn out to be comparatively large in order that a complete illumination of the field of view can still be achieved. By contrast, with larger working distance and/or increasing zoom-in, the parallax angle can turn out to be increasingly smaller. In this case, the relationship between current working distance in mm and chosen parallax angle in degrees can preferably be configured to be nonlinear.

Autofluorescence, which typically occurs at certain wavelengths e.g. in the near UV range, often leads to a reduction of the illumination intensity in the exciting wavelength range but also to an additional illumination intensity, on account of the wavelengths generated by the autofluorescence. This can lead to unwanted disturbance effects. In order to effect an improvement here, according to the invention, it can be provided that the materials used in the observation system are chosen such that such autofluorescence is prevented. By way of example, fused silica exhibits very little autofluorescence in the near UV range and may therefore be mentioned as one example of a suitable material for avoiding autofluorescence. It should also be noted here that the materials for the two MLAs can generally be chosen to be different.

### BRIEF DESCRIPTION OF THE DRAWINGS

The invention will now be described in more detail on the basis of exemplary embodiments, but is not restricted to these exemplary embodiments. Further implementations of the invention can be obtained from the following description of a preferred exemplary embodiment in conjunction with the general description, the claims, and the drawings.

In the following description of various preferred embodiments of the invention, elements that correspond in terms of their function are denoted by corresponding reference numerals, even in the case of a deviating design or shape.

In the figures:

FIG. 1 shows a side view of an illumination system configured according to the invention as part of an observation system that also comprises an imaging system,

FIG. 2 shows the observation system from FIG. 1 in a frontal view,

FIG. 3 shows a further example of an illumination system configured according to the invention,

FIG. 4 shows a plan view and two respective side views of a microlens array used in the illumination system in accordance with FIG. 3,

FIG. 5 shows a 3D view of further microlens arrays that could be used in an illumination system according to the invention,

FIGS. 6 and 7 show an application in which two illumination systems configured according to the invention are used together with an imaging system, and finally

FIG. 8 shows an illustration of a typical application in which the invention, more precisely an illumination system configured according to the invention, can advantageously be used.

### DETAILED DESCRIPTION

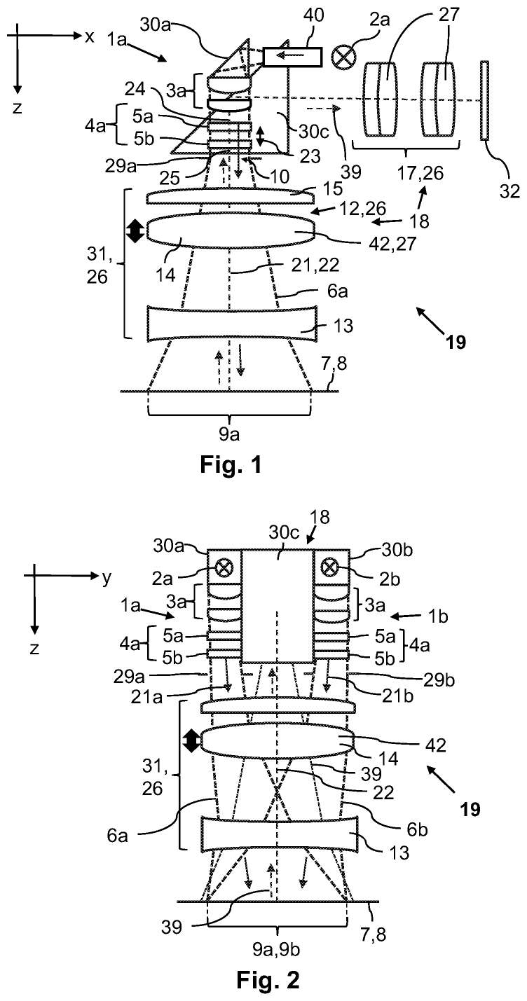

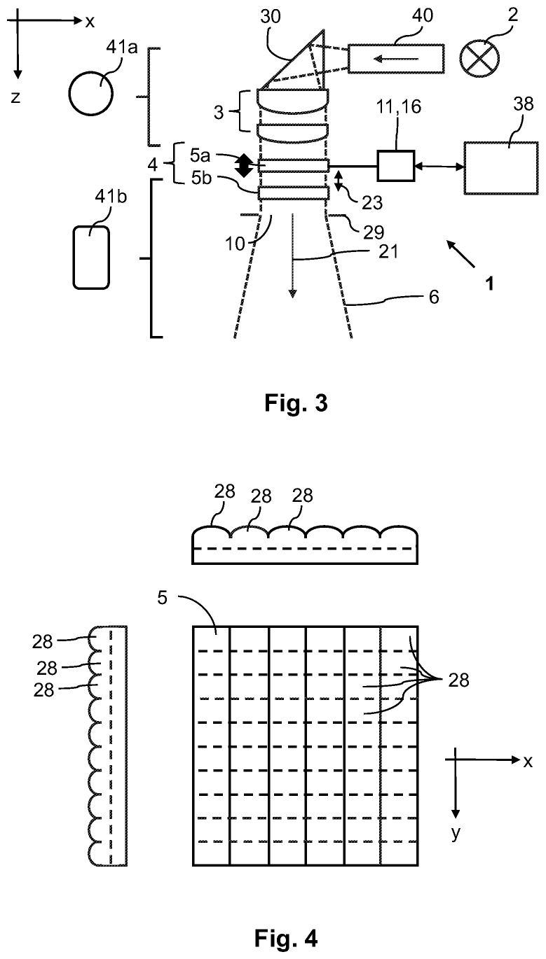

FIG. 3 shows a first example of an illumination system 1, which (for example as illustrated in FIG. 1) can be used for adaptively illuminating an object 7 situated in an object plane 8. This illumination system 1 is provided for use with an imaging system 18 (cf. FIG. 1) and forms an illumination beam path 6, wherein illumination light from a light source 2 as the starting point of an illumination beam path 6 firstly is coupled into a light guide 40, subsequently is deflected with the aid of a deflection element 30 in the form of a prism, and then firstly, as can be seen in FIG. 3, passes through a collector optical unit 3, which collects the light beams emerging from the end face of the light guide 40. Consequently, the end face of the light guide 40 in FIG. 3 thus forms the actual light source 2, while the illumination light is made available by the further primary light source 2. The collector optical unit 3 collimates the illumination light to the greatest possible extent before this light is incident on the downstream condensing optical unit 4, which is formed by two microlens arrays 5a and 5b spaced apart from one another and aligned parallel to one another.

As indicated by the reference sign 23 in FIG. 3, the axial distance 23 between the two microlens arrays 5a and 5b can be varied in order thus to tune an optical focal length of the condensing optical unit 4. For this purpose, the illumination system 1 has a setting means 11 in the form of an electronically controllable actuator 16, which is connected via a control line to a controller 38 and is controlled by the latter. If the axial distance 23 is adjusted with the aid of the actuator 16, then there is a change in a size of an illumination field 9 in the object plane 8 (cf. FIG. 1), which illumination field is supplied with illumination light by the condensing optical unit 4. This adaptive adaptation of the illumination field 9 by adjusting the axial distance 23 can take place here if a working distance between the object plane 8 and the condensing optical unit 4 either is unaltered or has been altered, for example, for instance because the entire illumination system 1 is positioned at a greater distance from the object 7.

What is not shown in the figures, but would be technically equivalent, is a configuration of the illumination system 1 in which the distance between the two microlens arrays 5a and 5b remains constant, but at least one of the two microlens arrays 5a and 5b is tuned, for instance by the focal length of the microlenses 28 of the affected microlens array 5a/5b being altered, in which case a corresponding actuator can of course be used for this purpose, too. It would be conceivable, for example, to use optofluidic microlenses 28 having a variable focal length in the respective microlens array 5a and/or 5b.

As in the case of the illumination system 1 in accordance with FIG. 3, in that in FIG. 1, too, it is evident that, proceeding from the collector optical unit 3, a beam 24 of the illumination beam path 6 is incident on the first of the two microlens arrays 5a. The two microlens arrays 5a and 5b reshape this incident beam 24 into an emerging beam 25 having a rectangular radiation cross section. This is illustrated in particular with the aid of the two intensity profiles 41a and 41b at the left-hand edge of FIG. 3: The intensity profile of the primary light source 2 but also of the end face of the light guide 40 has a rotationally symmetrical intensity distribution 41a. The two microlens arrays 5a and 5b convert this intensity distribution 41a into the rectangular intensity distribution 41b shown, which can have a format of 16:9, for example, which is advantageous for example if an image sensor of the same format is used in the associated imaging system 18.

Furthermore, the use of the two microlens arrays 5a and 5b affords the technical advantage that said intensity distribution 41b is homogenized, such that ultimately a rectangular illumination field 9 can be obtained with a homogeneous intensity distribution in the object plane 8.

FIG. 4 shows an example of a microlens array 5 which is configured on one side and which could be used in the condensing optical unit 4. Numerous microlenses 28 arranged on a regular grid are evident, each of which has a constant lens shape. It is furthermore evident that the respective lens aperture is configured to be rectangular. Since the microlenses 28 are arranged in the periodic pattern shown, an intensity profile with very little waviness can be obtained in the illumination field 9, such that the profile is similar to a so-called “flat-top”.

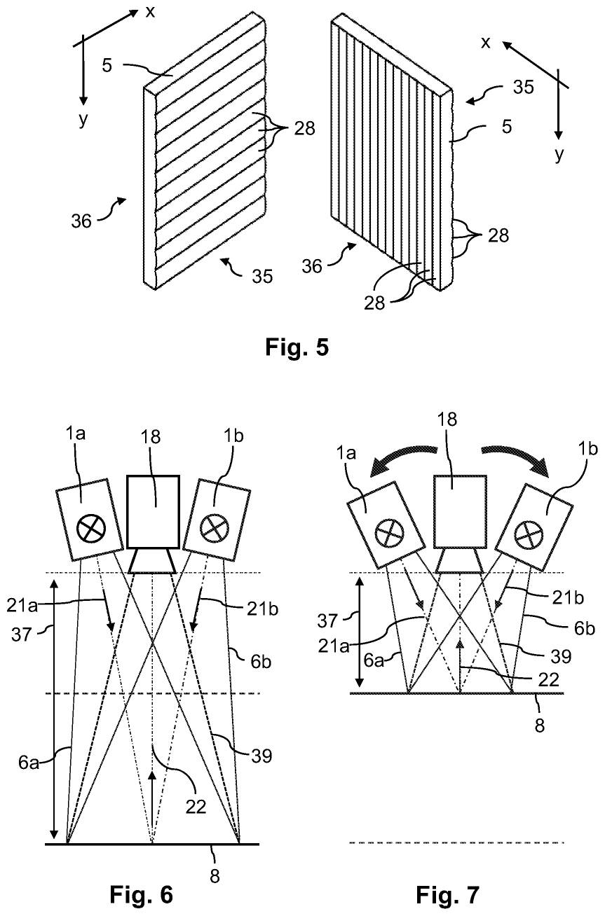

FIG. 5 shows a perspective view of a further microlens array 5, wherein the front side 35 of the microlens array 5 can be seen in the left-hand half of the figure, while the rear side 36 can be seen on the right-hand side. In this exemplary configuration, the microlenses 28 are each embodied as cylindrical lenses. It is furthermore evident that these cylindrical lenses on the front side 35 are oriented along the x-axis, while those on the rear side 36 are oriented orthogonally thereto along the y-axis. In other words, the microlens array 5 shown in FIG. 5 thus bears cylindrical lenses on both sides, the orientation of which lenses is rotated precisely by 90° between the front side 35 and the rear side 36.

The frontal view in FIG. 2 reveals that this observation system 19 configured according to the invention has, besides the imaging visualization system 18 shown, two illumination systems 1a and 1b each configured according to the invention, the side view in FIG. 1 illustrating only the left-hand illumination system 1a together with the visualization system 18. The visualization system 18 comprises an imaging optical unit 26 formed by the objective 31 shown, which consists of a plurality of lenses, and two further imaging lenses 27, the latter imaging the object 7 onto the image sensor 32 shown. The objective 31 comprises a further lens 14 besides the two stationary lenses 13 and 15, said further lens being configured to be displaceable axially along the optical axis 22, whereby a movable focusing optical unit is realized. With the aid of this focusing optical unit, different working distances 37 (cf. the example in FIGS. 6 and 7) can be set, such that it is possible to focus objects 7 at different distances from the visualization system 18.

The visualization system 18 furthermore has a tunable focus optical unit 12, such that the system 18 can supply a sharp image in each case for working distances of different magnitudes. Furthermore, the visualization system 18 also has a zoom optical unit 17, which enables a zoom level to be adapted (cf. FIG. 1).

If a surgeon using the visualization system 18 in a medical intervention carries out a zoom-out with constant working distance, for example, then the field of view that is imaged onto the image sensor 32 is enlarged. This may be expedient e.g. in order to provide an overview of an operation area. The surgeon may subsequently perform a zoom-in, in which case the field of view then turns out to be smaller but more details become discernible in the image currently being captured. In such situations, the two illumination systems 1a and 1b can each be adjusted such that, in reaction to the performed adaptation of the optical zoom (wherein the working distance can remain constant here under certain circumstances), a size of the respective illumination field 9a, 9b (cf. FIG. 2) is adapted by the respective condensing optical unit 4a/4b being adjusted. For this purpose, the axial distance 23 between the respective two microlens arrays 5a and 5b is in each case adjusted. This can be conceived of in a simplified way such that the condensing optical unit 4 likewise performs an optical zoom, but relative to the illumination field 9 which results in the object plane 8. This adaptation of the illumination field can be performed in an automated manner by an electronic controller 38 (as shown in FIG. 3, for instance) controlling a respective setting means 11 for adjusting the condensing optical units 4a, 4b.

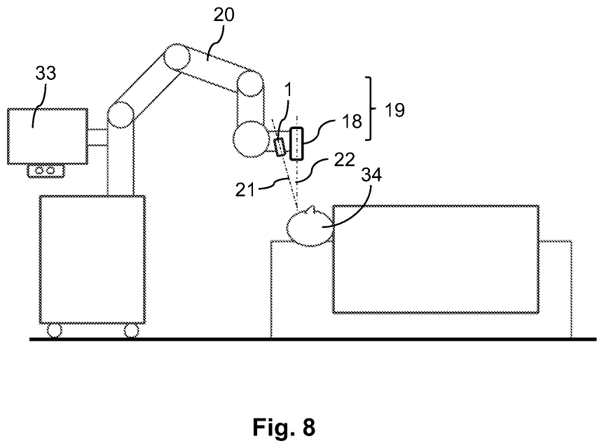

As illustrated in FIG. 8, an illumination system 1 according to the invention together with an associated visualization system 18 in the form of a surgical microscope can be arranged on a robotic arm 20 in order to be able to be positioned together in space, relative to its patient 34. The invention can thus be used in an advantageous manner in particular in a medical robotics system. In this case, the surgeon can view a live image recorded by the visualization system 18 on the monitor 33 and, via a remote control, can operate/control both the robotic arm 20 and the focusing unit and the optical zoom 12 of the visualization system 18. The illumination system then adapts the size of the illumination field 9 in each case automatically in reaction to an adjustment of the focal plane or a change in the optical zoom, by adjusting the condensing optical unit 4, as described above.

The condensing optical unit 4 can thus be adjusted in such a way in particular in reaction to an adaptation of a spatial pose of a focal plane of the visualization system 18, i.e. if the working distance 37 of the visualization system 18 is adapted, for example by the surgeon, using the focusing optical unit described. Specifically, in such a case as well, the illumination field 9 can be correspondingly adapted in terms of its size in a new object plane 8 by adjusting the axial distance 23 between the two microlens arrays 5a and 5b. What can be achieved as a result is that the entire field of view that is currently observed by the visualization system 18 and displayed on the monitor 33 is always sufficiently illuminated by the illumination beam path 6.

In the case of the overall system shown in FIG. 8, an electronic control loop is implemented between the illumination system 1 and the visualization system 18 in such a way that the illumination system 1 automatically and independently adapts the size of the generated illumination field 9 as soon an optical zoom of the visualization system 18 or a spatial pose of the focal plane of the visualization system 18 is altered. If the surgeon carries out a zoom-in using the visualization system 18, for example, then the size of the illumination field 9 automatically decreases. Since the illumination intensity in the illumination field 9 also increases in this case, what can additionally be implemented is that a light power of the light source 2 is automatically readjusted in order to avoid an excessive irradiation of the object plane 8.

FIG. 8 furthermore reveals that the optical axis 21 of the illumination system 1 and the optical axis 22 of the visualization system 18 are arranged at a parallax angle with respect to one another.

It is readily discernible in FIG. 1 that the illumination beam path 6 therein runs both through the axially movable focusing optical unit described, realized by the axially displaceable imaging lens 42, but also through the two stationary lenses 13 and 15 of the objective 31. However, other configurations are also conceivable: By way of example, the third lens 15 would not necessarily need to be configured to be stationary, rather a plurality of optical lenses of the objective 31 could also be configured to be displaceable. By way of example, an observation system 19 according to the invention can also be set up such that the illumination beam path 6 of the illumination system 1 runs under the imaging beam path 39 of the imaging system 18 through two jointly used lens group; in this case, for example, one of the lens groups can be configured to be stationary and the other can be configured to be axially displaceable.

In the example in FIGS. 1 and 2, therefore, the illumination light emitted by the respective illumination system 1a, 1b, after collimation by the corresponding collector optical unit 3 and after passing through the two microlens arrays 5a and 5b, which perform beam shaping and beam homogenization, is guided through two stationary imaging lenses 27 of the imaging optical unit 26 of the visualization system 18, namely the two lenses 13 and 15, wherein the illumination light finally reaches the object plane 8 observed by the visualization system 18, in order to illuminate the illustrated respective illumination field 9a, 9b there. This approach has the major advantage that narrow cavities, such as body cavities, for example, which are observed by the visualization system 18 can be illuminated by the two illumination systems 1a and 1 b approximately in a manner free of shading.

If, in the case of the observation system 19 in accordance with FIGS. 1 and 2, the displaceable imaging lens 42 of the visualization system 18 is displaced axially along the optical axis 21, then as a result not only is there a change in the field of view and in a working distance 37 of the visualization system 18, but there is also a change in the size of the illuminated illumination field 9, specifically because the illumination beam path 6 likewise runs through said imaging lens 42.

FIGS. 6 and 7 illustrate that, in the case of an observation system 19 according to the invention, the respective optical axes 21a, 21b of the two illumination systems 1a and 1b used can be configured to be tiltable, such that the parallax angle that exists between the respective optical axis 21 and the optical axis 22 of the visualization system 18 can be adapted depending on the current pose of the focal plane or working distance 37. For this purpose, however, the entire illumination system 1 need not necessarily be tilted, as illustrated in FIGS. 6 and 7; rather, for example, a condenser lens of the condensing optical unit 4 can also be displaced transversely with respect to the optical axis 21 in order to attain the desired tilting of the optical axis 21. Accordingly, the illumination system 1 can thus comprise such a condenser lens that is displaceable transversely with respect to the optical axis 21.

In summary, in order to improve the luminous efficiency but also the compactness of an illumination system 1 which can be used together with an imaging visualization system 18, it is proposed that the illumination system 1 comprises two microlens arrays 5a and 5b, which are either displaceable relative to one another along an optical axis or wherein at least one of the two microlens arrays 5a, 5b is configured to be optically tunable, such that in each case an effective focal length of the condensing optical unit 4 formed by these microlens arrays 5a and 5b is variable. This approach has the advantage that the size of an illumination field 9 illuminated by the condensing optical unit 4 can be adapted situation-dependently and extremely rapidly, in particular if a focal plane observed by the visualization system 18 is displaced or if, for example, an optical zoom 12 of the visualization system 18 is altered. As a result, an optimum illumination of the respective field of view can always be guaranteed, in particular without a portion of the illumination beam path 6 of the illumination system 1 having to be stopped down to a greater or lesser extent for this purpose (cf. FIG. 1).

### LIST OF REFERENCE SIGNS

1 Illumination system
2 Light source
3 Collector optical unit (for collecting light beams emerging from 2)
4 Condensing optical unit, in particular configured as condensing lens group
5 Microlens array
6 Illumination beam path (proceeds from 2, is delimited by 5)
7 Object
8 Object plane (the object to be observed/to be illuminated is situated here)
9 Illumination field (defined by 5/4)
10 Stop aperture (defined by 5/29)
11 Setting means (for adjusting 4)
12 Focus optical unit
13 First lens
14 Second lens
15 Third lens
16 Actuator
17 Zoom optical unit
18 Imaging system, in particular configured as medical visualization system (e.g. as microscope, exoscope or endoscope)
19 Observation system
20 Robotic arm
21 Optical axis (of 1)
22 Optical axis (of 18)
23 Axial distance (between 5a and 5b)
24 Incident beam (emerging from 3, incident on 4)
25 Emerging beam (emitted by 4)
26 Imaging optical unit (can also concomitantly comprise a zoom optical unit)
27 (Optical) imaging lenses
28 Microlenses
29 Luminous field stop
30 Deflection element (e.g. configured as prism or mirror)
31 Objective (of 18)
32 Image sensor
33 Monitor
34 Patient
35 Front side
36 Rear side
37 Working distance
38 Controller
39 Imaging beam path (of 26/18)
40 Light guide
41 Intensity profile or intensity distribution
42 Axially displaceable imaging lens

1. An illumination system (1) for adaptively illuminating an object (7) situated in an object plane (8), with an illumination beam path (6), the illumination system (1) being adapted for use with an imaging system (18), the illumination system (1) comprising:
a light source (2) as a starting point of the illumination beam path (6);
a collector optical unit (3) for collecting light beams emerging from the light source (2); and
a condensing optical unit (4) for illuminating the object plane (8), the condensing optical unit (4) comprises two microlens arrays (5a, 5b), wherein at least one of
a) an axial distance (23) between the two microlens arrays (5a, 5b), is configured to be adjustable along an optical axis (21), or
b) at least one of the two microlens arrays (5a, 5b) is configured to be optically detunable.

2. The illumination system (1) as claimed in claim 1, wherein an optical focal length of the condensing optical unit (4) is tunable by at least one of
a) adjusting the axial distance (23) between the two microlens arrays (5a, 5b), or
b) by detuning at least one of the two microlens arrays (5a, 5b).

3. The illumination system (1) as claimed in claim 1, wherein a size of an illumination field (9) in the object plane (8), which illumination field is supplied with illumination light by the condensing optical unit (4), is adaptable by at least one of a) adjusting the axial distance (23) between the two microlens arrays (5a, 5b), or b) by detuning at least one of the two microlens arrays (5a, 5b).

4. The illumination system (1) as claimed in claim 1, wherein the two microlens arrays (5a, 5b) are configured to shape an incident beam (24) of the illumination beam path (6) into an emerging beam (25) which results in a rectangular format, and the light source (2) supplies a non-rectangular intensity distribution (41a).

5. The illumination system (1) as claimed in claim 4, wherein the two microlens arrays (5a, 5b) cause an optical homogenization of an intensity distribution (41b) within the rectangular illumination field (9), in comparison with an intensity distribution of the light source (2) of the illumination system (1).

6. The illumination system (1) as claimed in claim 4, wherein both of the microlens arrays (5a, 5b) each have microlenses (28) on both sides.

7. The illumination system (1) as claimed in claim 1, wherein at least one of:
a) the two microlens arrays (5a, 5b) each have microlenses (28) having at least one of a rectangular basic shape or optical aperture,
b) the microlenses (28) of the two microlens arrays (5a, 5b) are arranged in a respective periodic pattern such that a flat-top intensity profile with a waviness of less than 15% is attained in the illumination field (9),
c) at least one of the two microlens arrays (5a, 5b) includes microlenses (28) with an aspherical contour,
d) at least one of the two microlens arrays (5a, 5b) has cylindrical lenses, or
e) at least one of the two microlens arrays (5a, 5b) has cylindrical lenses on both sides, wherein an orientation of these cylindrical lenses is rotated by 90° between a front side (35) and a rear side (36).

8. The illumination system (1) as claimed in claim 1, wherein the illumination system (1) comprises setting means (11) by which the axial distance (23) between the two microlens arrays (5a, 5b) is adjustable.

9. The illumination system (1) as claimed in claim 1, wherein in at least two different adjustments of the condensing optical unit (4) a quantity of light of the illumination beam path (6) which is provided by the light source (2) and which leaves the collector optical unit (3) at least one of a) completely passes through the two microlens arrays (5a, 5b), or b) is completely usable for illuminating the illumination field (9).

10. The illumination system (1) as claimed in claim 1, wherein an entire light beam emitted by the collector optical unit (3), in all settable relative positions of the two microlens arrays (5a, 5b), exits as a shaped beam from a back one of the two microlens arrays (5b).

11. The illumination system (1) as claimed in claim 1, wherein the light source (2) is formed by the end face of a light guide (40), and the end face emits light with a maximum emission angle of less than 40°.

12. A method of illuminating an object plane (8) which is simultaneously observed by an imaging visualization system (18), the method comprising
providing the illumination system of claim 1,
in reaction to at least one of an adaptation of an optical zoom, with constant working distance (37) between the object plane (8) and the condensing optical unit (4), or an adaptation of a spatial pose of a focal plane of the visualization system (18), adapting a size of the illumination field (9) in the object plane (8) byway of the condensing optical unit (4), by adjusting the axial distance (23) between the two microlens arrays (5a, 5b).

13. The method of claim 12, wherein the visualization system (18) is configured as a microscope, an exoscope or an endoscope, and the method further comprises positioning the visulaization system together with the illumination system (1) by a robotic arm (20) in space at a predeterminable working distance from the object (7) to be observed.

14. The method aw claimed in claim 12, wherein an electronic control loop is implemented between the illumination system (1) and the visualization system (18), such that the illumination system (1) automatically and independently performs the adaptation of the size of the illumination field (9) as soon as a user of the visualization system (18) alters an optical zoom thereof or a spatial pose of the focal plane of the visualization system (18), such that during a zoom-in carried out by the visualization system (18), at least one of a) a size of the illumination field (9) automatically decreases, or b) an illumination intensity in the illumination field (9) increases.

15. A method for shading-free illumination of a cavity which is observed by a visualization system (18), the method comprising:
at least approximately collimating illumination light emerging from a light source (2) via a collector optical unit (3),
subsequently guiding the illumination light through two successive microlens arrays (5a, 5b), which perform beam shaping and beam homogenization, and
subsequently passing the illumination light through at least two imaging lenses (27) of an imaging optical unit (26) of the visualization system (18) right into an object plane (8) observed by the visualization system (18), said object plane lying within the cavity.

16. An observation system (19), in particular for medical applications, comprising:
at least one of the illumination systems (1) as claimed in claim 1, and
an imaging visualization system (18) offering a variable optical zoom, wherein
the illumination beam path (6) of the illumination system (1) is passed through at least one imaging lens (27) of the visualization system (18).

17. The observation system (19) as claimed in claim 16,
wherein the observation system (19) is mounted on a movable robotic arm (20), by which the observation system (19) is arrangeable in space in at least one of different positions or different viewing directions, and
wherein at least one optical axis (21) of the at least one illumination system (1) and an optical axis (22) of the visualization system (18) are arranged at a parallax angle with respect to one another.

18. The observation system (19) as claimed in claim 17, wherein the illumination beam path (6) runs through an axially displaceable imaging lens (42) of the visualization system (18), such that a change in a size of an illumination field (9) illuminated by the illumination beam path (6) together with a change in at least one of a field of view or a working distance (37) of the visualization system (18) are achievable by axial displacement of said imaging lens (2).

19. The observation system (19) as claimed in claim 18, wherein the parallax angle is configured to be variable, at least one of the optical axis (21) of the illumination system (1) or the optical axis (22) of the visualization system (18) is configured to be tiltable, wherein a conversion mechanism is implemented, such that an adjustment of a focusing optical unit of the visualization system (18) that serves for adapting the spatial pose of the focal plane is convertible into a corresponding tilt of the optical axis (21) of the illumination system (1) such that the parallax angle is automatically adaptable depending on a current pose of the focal plane.

20. The observation system (19) as claimed in claim 18, wherein the optical axis (21) of the illumination system (1) is tiltable via a condenser lens of the condensing optical unit (4) that is configured to be at least one of displaceable or tiltable transversely with respect to this optical axis (21) or via the entire illumination system (1) being configured to be tiltable in relation to the visualization system (18).
